(19) United States
(12) Patent Application Publication
(10) Pub. No.: US 2022/0198839 A1
(43) Pub. Date: Jun. 23, 2022

(54) DISTRIBUTED DATA PROCESSING TASK ALLOCATION SYSTEMS AND METHODS FOR AUTONOMOUS VEHICLES

(71) Applicant: Sensible 4 Oy, Espoo (FI)

(72) Inventors: Harri Santamala, Veikkola (FI); Jussi Suomela, Espoo (FI)

(73) Assignee: Sensible 4 Oy, Espoo (FI)

(21) Appl. No.: 17/553,714

(22) Filed: Dec. 16, 2021

Related U.S. Application Data
(60) Provisional application No. 63/129,287, filed on Dec. 22, 2020.

(51) Int. Cl. G07C 5/00; B60W 60/00; H04W 4/44

(52) U.S. Cl. CPC G07C 5/008; B60W 60/001; B60W 2420/42; B60W 2420/52; H04W 4/44

(57) ABSTRACT

Embodiments of the disclosed systems and methods provide techniques for dynamically allocating processing tasks between in-vehicle and remote processing resources. In various embodiments, aspects of the disclosed systems and methods may advantageously use relatively low latency edge cloud and/or cloud processing resources accessed via higher speed wireless networks to enhance processing resources available to a vehicle for use in a variety of control and/or operation decisions. Consistent with various disclosed embodiments, processing tasks may be dynamically allocated based on relative impact and/or importance to safe vehicle operation, network latency between a vehicle and remote processing resources, available network bandwidth between a vehicle and remote processing resources, network traffic, processing complexity, processing resource availability, and/or the like.

### RELATED APPLICATIONS

This application claims benefit of priority under 35 U.S.C. § 119(e) to U.S. Provisional Patent Application No. 63/129,287, filed Dec. 22, 2020, and entitled “DISTRIBUTED DATA PROCESSING TASK ALLOCATION SYSTEMS AND METHODS FOR AUTONOMOUS VEHICLES,” which is incorporated herein by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to systems and methods for managing and processing data associated with autonomous vehicles (“AVs”). More specifically, but not exclusively, the present disclosure relates to systems and methods for managing and processing data associated with AVs using remote processing resources.

Autonomous and/or self-driving and/or semi-autonomous vehicles may generate and/or use a wide variety of data during operation. For example, vehicle sensors such as light detection and ranging (“LIDAR”) sensors, radio detection and ranging (“RADAR”) sensors, vision sensors (e.g., cameras), and/or the like may produce a large amount of data during vehicle operation that may be used in a number of operational contexts and/or control decisions. Effectively utilizing such information in connection with vehicle control decisions may involve relatively significant usage of high-performance computing resources, introducing some limits on the development of autonomous driving control algorithms and associated systems. In-vehicle processing resources, while having recently grown significantly more capable, may be nevertheless be somewhat limited. Artificial intelligence (“AI”) and other processing methods may help local vehicle processing better utilize vehicle data (e.g., AI-assisted point-cloud and/or image processing methods), but limitations of in-vehicle processing resources may still prove challenging.

Embodiments disclosed herein provide for distributed data processing systems and methods that may help ameliorate challenges associated with more limited in-vehicle processing resources. In certain embodiments, data processing activities associated with a vehicle, which may be an AV and/or other self-driving vehicle, a semi-autonomous vehicle, a vehicle with advanced driver assist systems, and/or the like, may be performed using in-vehicle, edge cloud, and/or cloud processing resources, and/or combinations of in-vehicle and/or and remote processing resources. In some embodiments, aspects of the disclosed systems and methods may provide low latency computing capacity accessed via higher speed wireless networks such as, for example and without limitation, 5G, Long-Term Evolution (“LTE) networks, and/or or public LTE networks.

Further embodiments disclosed herein provide for intelligent dynamic allocation of processing tasks between in-vehicle and/or remote processing resources. For example, some out-of-vehicle processing may be associated with safety risks in cases where certain operational responsibility and/or control decisions are not performed local to the vehicle. In various embodiments of the disclosed systems and methods, processing tasks may be dynamically allocated such that those tasks that should be performed local to the vehicle (e.g., for safety and/or other considerations) may performed locally by in-vehicle processing resources, while other less safety-critical tasks may be performed remotely by an edge cloud processing resource (e.g., enriching locally performed calculations and/or the like). In certain embodiments, processing tasks may be dynamically allocated between in-vehicle processing resources and remote resources, such as edge cloud and/or cloud processing resources based, at least in part, on identified real-time network latency, bandwidth, processing availability, and/or other network conditions.

### BRIEF DESCRIPTION OF THE DRAWINGS

The inventive body of work will be readily understood by referring to the following detailed description in conjunction with the accompanying drawings, in which:

FIG. 1 illustrates a non-limiting example of a high-level architecture for managing and processing data associated with a vehicle consistent with certain embodiments of the present disclosure.

FIG. 2 illustrates a flow chart of a non-limiting example of a method of dynamically allocating processing tasks associated with vehicle operation consistent with certain embodiments of the present disclosure.

FIG. 3 illustrates a flow chart of a non-limiting example of a method of dynamically allocating processing tasks based on communication channel latency consistent with certain embodiments of the present disclosure.

FIG. 4 illustrates a non-limiting example of a system that may be used to implement certain embodiments of the systems and methods of the present disclosure.

### DETAILED DESCRIPTION

A description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may in some instances be designated by like numbers and/or descriptions. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods provide techniques for dynamically allocating processing tasks between in-vehicle, edge cloud, and/or cloud processing resources. In various embodiments, aspects of the disclosed systems and methods may advantageously use relatively low latency edge cloud and/or cloud processing resources accessed via higher speed wireless networks to enhance processing resources available to a vehicle for use in a variety of control and/or operation decisions. Consistent with various disclosed embodiments, processing tasks may be dynamically allocated based on relative impact and/or importance to safe vehicle operation, network latency between a vehicle and remote processing resources (e.g., edge cloud and/or cloud processing resources), available network bandwidth between a vehicle and remote processing resources (e.g., edge cloud and/or cloud processing resources), network traffic, processing complexity, processing resource availability, and/or the like.

In certain embodiments, local and/or remote vehicle operators may be further able to adjust processing tasks allocation settings and/or priorities. For example, a remote vehicle operator and/or supervisor may be able to switch allocation of tasks to remote processing resources off or specify that tasks (or certain tasks) should be allocated to remote processing resources only under certain operating conditions. In this manner, processing task allocation may be adjusted (e.g., adjusted “on the fly” and/or in advance) based on experienced operating conditions and/or anticipated operating conditions.

Although various embodiments are generally described herein as being used in connection with AVs for purposes of illustration and explanation, it will be appreciated that the described embodiments of the disclosed systems and methods may be used in connection with fully autonomous, semi-autonomous, and/or other assisted driving vehicles (e.g., assisted driving vehicles driven at least in part by an in-vehicle driver and/or a remote operator). Moreover, it will be appreciated that various aspects of the disclosed embodiments may be used in connection with a variety of types of vehicles including, for example and without limitation, passenger vehicles, transit vehicles, freight vehicles, land-based vehicles, watercraft, aircraft, and/or the like.

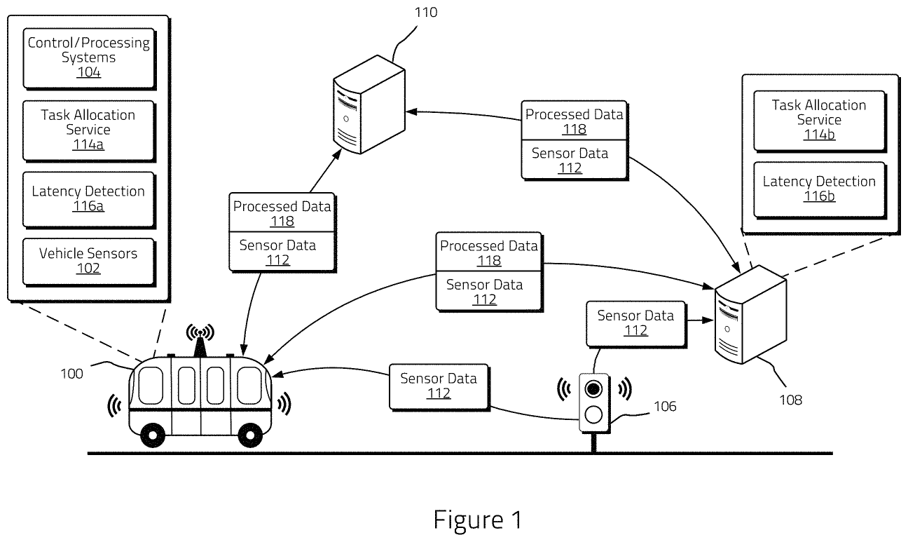

FIG. 1 illustrates a non-limiting example of a high-level architecture for managing and processing data associated with a vehicle consistent with certain embodiments of the present disclosure. An AV 100 may include one or more sensors 102 configured to generate and/or otherwise provide various data associated with the AV 100 and/or its surrounding environment (e.g., information relating to a roadway). A variety of sensors 102 may be used in connection with various embodiments disclosed herein. For example and without limitation, an AV 100 may comprise one or more Global Navigation Satellite System (“GNSS”) systems and/or other location sensors, GPS systems, vehicle speed sensors (“VSSs”), accelerometers, LIDAR sensors, cameras and/or other visual sensors, RADAR sensors, weather and environmental sensors, odometers, kinematic sensors, and/or any other type of sensor that may be included in a vehicle.

Information received from such sensor systems 102 may provide vehicle control and/or processing systems 104 with contextual information relating to an environment around an AV 100 including, for example and without limitation, object identification and/or detection information (e.g., obstacles, other vehicles, pedestrians, and/or the like), road condition (e.g., estimates of friction conditions, presence of water on the road, etc.) and/or lane information, weather and/or other environmental information, and/or the like. Information received from and/or otherwise generated by vehicle sensor systems 102 may be collectively referred to herein in certain instances as vehicle sensor data and/or derivatives of the same.

In certain embodiments, one or more infrastructure sensors 106 (e.g., road crossing sensors and/or the like) may be employed that may not necessarily be integrated into an AV 100 but may generate and share information relating to the vehicle AV and/or its surrounding environment with vehicle control and/or processing systems 104 and/or separate systems associated with the vehicle. For example, in various embodiments, one or more infrastructure sensors 106 may communicate information relating to vehicle operation with edge cloud processing resources 108 and/or cloud processing resources 110. Information generated and/or otherwise shared by the one or more infrastructure sensors 108 may be used by vehicle control and/or processing systems 104, edge cloud processing resources 108 and/or associated systems, and/or cloud processing resources 110 and/or associated systems in connection with various vehicle operational control decisions.

A variety of infrastructure sensors 106 may be used in connection with the disclosed embodiments. Infrastructure sensors 106 may comprise, for example and without limitation, perception sensors such as cameras, LIDAR sensors, RADAR sensors, environmental sensors, speed sensors, weather and/or environmental sensors, and/or any other type of sensor that may be used to generate information relating to a AV 100 and/or an environment associated with the AV 100, which may include an environment proximate to the vehicle and/or an environment along a path transited by the AV 100 (e.g., a roadway). Information received from and/or otherwise generated by infrastructure sensors 106 may be collectively referred to herein in certain instances as infrastructure sensor data and/or derivatives of the same.

In various embodiments, infrastructure sensors may be placed in a variety of locations to provide information relating to an AV 100 and/or its associated environment. For example and without limitation, infrastructure sensors 106 may be placed along roadways transited by an AV 100, proximate to intersections along and/or blind spots along vehicle travel paths and/or routes, and/or the like. In various embodiments, infrastructure sensors 106 may provide information used in a variety of contexts including, for example and without limitation, object detection and/or mapping, weather information, localization, mapping, and/or other processes associated with vehicle operation. In at least one non-limiting example, larger weather sensing systems may be difficult to integrate into an AV platform due to economical and/or physical constraints. Accordingly, such sensing systems may be implemented as infrastructure sensors 106 used to provide high quality information relating to meteorological visibility, which may be useful for object detection, localization, mapping, and/or safety aspects of vehicle operation.

As detailed above, a variety of processing resources may be available to the AV 100. For example, the AV 100 may comprise certain local and/or on-board control and/or processing systems 104, which may in certain instances be referred to herein as local and/or in-vehicle processing resources and/or systems and/or derivatives of the same. The AV 100 may further be capable of communicating with remote processing and/or computing systems and/or resources 108, 110 that may include, for example and without limitation, edge cloud processing resources 108 and/or cloud processing resources 110.

Consistent with embodiments disclosed herein, edge cloud processing resources 108 may be deployed at the and/or near an edge of a wireless network in communication with an AV 100, and may be associated with relatively shorter network latency than cloud processing resources 110. Although illustrated as being separate from the illustrated infrastructure sensor 106, it will be appreciated that in other embodiments, edge cloud processing resources 108 and infrastructure sensor systems 106 may be integrated into a single platform and/or system.

The AV 100 and/or associated local control and/or processing systems 104 may communicate with remote processing resources (e.g., edge cloud and/or cloud processing resources 108, 110) and/or infrastructure sensor systems 106 using a variety of suitable network connections implementing a variety of suitable communication technologies, channels, standards, and/or protocols. For example and without limitation, the AV 100 and/or associated local processing resources 104 may communicate with remote processing resources 108, 110 and/or infrastructure sensor systems 106 using, for example and without limitation, ITS 5G, WiFi, Bluetooth, Long Term Evolution (“LTE”) wireless network standards and/or protocols, 5G, 6G wireless network standards and/or protocols, country specific technologies and/or frequencies for transmitting data, and/or any other suitable communication network standard, protocol, technology, and/or combinations thereof. Various remote processing resources 108, 110 and/or infrastructure sensor systems 106 may communicate with each other using a variety of suitable wired and/or wireless communication technologies, channels, standards, and/or protocols, including any of the standards and/or protocols detailed herein.

For purposes of simplicity and explanation, vehicle sensor data and/or infrastructure sensor system may be referred to and/or illustrated in connection with FIG. 1 generally as sensor data 112. It will be appreciated, however, that depending on the context and/or implementation, consistent with various disclosed embodiments sensor data 112 as illustrated in FIG. 1 may comprise information generated by a vehicle sensor system 102, an infrastructure sensor system 106, and/or data generated by both a vehicle sensor system 102 and an infrastructure sensor system 106. For example, sensor data 112 originating from a vehicle sensor 102 may be communicated to edge cloud processing resources 108. This received vehicle sensor data may be aggregated by the edge cloud processing resources 108 with data received by the edge cloud processing resources 108 from an infrastructure sensor system 106, and the aggregated data may be communicated to cloud processing resources 110. In this manner, the cloud processing resources 110 may receive as part of sensor data 112 information generated by both the vehicle sensor system 102 and the infrastructure sensor system 106.

As illustrated, sensor data 112 generated by vehicle sensor systems 102 may be communicated from the AV 100 to one or more cloud processing resources 110 and/or edge cloud processing resources 108. In further embodiments, sensor data 112 generated by vehicle sensor systems 102 may alternatively and/or additionally be shared with one or more other services and/or platforms, including infrastructure sensor systems 106 (which in some implementations, and as discussed below, may act as an intermediary system).

Sensor data 112 generated by an infrastructure sensor system 106 may be communicated from the infrastructure sensor system 106 to the AV 100 and/or associated control and/or processing systems 104, the edge cloud processing resources 108, and/or the cloud processing resources 110. In some embodiments, one or more of the AV 100, the edge cloud processing resources 108, and/or the cloud processing resources 110 may operate as an intermediary and/or data aggregator. For example, the edge cloud processing resources 108 may aggregate vehicle sensor data received from the AV 100 and infrastructure sensor data received from the infrastructure sensor system 106 and communicate the aggregated data to the cloud processing resources 110 as sensor data 112.

As noted above, in various embodiments, one or more systems, services, and/or vehicles, including the AV 100, edge cloud processing resources 108, and cloud processing resources 110, may act as data aggregation and/or communication intermediaries. For example and without limitation, in some embodiments, infrastructure sensor data may be communicated from the infrastructure sensor system 106 to the AV 100 which in turn may communicate the received infrastructure sensor data to the cloud processing resources 110. In some embodiments, the AV 100 may aggregate such infrastructure sensor data with vehicle sensor measurement data and communicate the aggregated data to the cloud processing resources 110 as sensor data 112. In further embodiments, the AV 100 may communicate the infrastructure sensor data separately from vehicle sensor measurement data. The edge cloud processing resources 108 and/or cloud processing resources 110 may similarly operate as data aggregators and/or intermediaries in connection with various aspects of the disclosed embodiments.

Sensor data received from vehicle and/or infrastructure sensor systems 106 may be analyzed and/or otherwise used by vehicle control and/or processing systems 104 to provide contextual information relating to environment around an AV 100 including, for example and without information, object identification and/or detection information, road condition and/or lane information, weather and/or other environmental information, dynamic map updating, and/or the like. This information may be used in a variety of contexts including, for example and without limitation, in connection with AV control and/or operation decisions.

Consistent with various embodiments disclosed herein, processing tasks using sensor data 112 generated by local vehicle sensors 102 and/or infrastructure sensors 106 may be dynamically allocated between vehicle control and/or processing systems 104, edge cloud processing resources 108, and/or cloud processing resources 110. Such dynamic allocation may be based, at least in part, on operational context of the AV 100.

For example, certain out-of-vehicle processing (e.g., processing by edge cloud processing resources 108 and/or cloud processing resources 110) may be associated with safety risks in cases where operational responsibility and/or control decisions impacting operational safety are not performed local to the AV 100. In various embodiments of the disclosed systems and methods, processing tasks may be allocated such that those tasks that should be performed local to the AV 100 may performed locally by in-vehicle processing resources (e.g., by local control and/or processing systems 104), while other less safety-critical tasks may be performed remotely by edge cloud processing resources 108 and/or cloud processing resources 110.

In further embodiments, certain processing tasks performed remotely by edge cloud processing resources 108 and/or cloud processing resources 110 may be used to enrich locally performed calculations by the vehicle control and/or processing systems 104. For example, less precise and/or lower resolution weather detection processing tasks may be performed locally by vehicle control and/or processing systems 104, which may be supplemented with information from more intensive processing by edge cloud processing resources 108 and/or cloud processing resources 110.

In various embodiments, allocating processing tasks and/or aspects thereof may be performed by a task allocation service 114a executing on a system local to the AV 100 (e.g., executing on vehicle processing resources such as vehicle control and/or processing system 104). In further embodiments, processing task allocation and/or aspects thereof may be performed by a task allocation service 114b executing on an edge cloud processing system and/or resources 108. In yet further embodiments, allocation of processing tasks and/or aspects thereof may be further performed using cloud services, systems, and/or associated processing resources 110.

In some embodiments, task allocation may be performed as part of a process involving interaction between one or more of the vehicle control and/or processing systems 104, the edge cloud processing resources 108, and/or the cloud processing resources 110. In certain embodiments, one or more of the vehicle control and/or processing systems 104, the edge cloud processing resources 108, and/or cloud processing resources 110 may interact and/or otherwise communicate to coordinate efforts to dynamically allocate, assign, and/or otherwise send processing tasks and/or associated sensor data 112 and/or coordinate the return of associated responses (e.g., processed data 116) between the system 104 and/or resources 108, 110. In some implementations, one or more of the one or more of the vehicle control and/or processing systems 104, the edge cloud processing resources 108, and/or cloud processing resources 110 and/or associated components may exchange messages relating to associated processing availability, processing latency, processing queues, network latency, bandwidth, and/or the like, which may be used in connection with dynamic allocation and/or assignment of tasks between the vehicle system 104 and/or remote processing resources 108, 110.

For example, a task allocation service 114a associated with an AV 100 may interact with a task allocation service 114b associated with edge cloud processing resources 108 to determine processing availability, latency and/or queues, network latency, bandwidth, and/or the like associated with the vehicle control and/or processing systems 104 and/or the edge cloud processing resources 108. The task allocation services 114a and/or 114b may further assess the determined latencies, processing queues, communication channel bandwidths, and/or the like relative to one or more parameters and/or variables associated with one or more processing tasks. Based on the assessment, processing task(s) and/or aspects thereof may be allocated between vehicle control and/or processing systems 104 and/or the edge cloud processing resources 108.

Processing tasks may be allocated between the between vehicle processing systems 104 and/or remote resources 108, 110 based on a variety of parameters and/or variables associated with a task, which in some embodiments may depend on an operational context associated with the task and/or the associated AV 100. In some embodiments, processing task parameters and/or variables may be associated with processing availability and/or processing latency of vehicle processing systems 104 and/or remote resources 108, 110. In further embodiments, processing task parameters and/or variables may be associated with network conditions associated with communication between vehicle processing systems 104 and/or remote resources 108, 110.

Processing task parameters and/or variables may be expressed in generalized indications (e.g., low network latency, high processing complexity, etc.), threshold ranges (e.g., between 100-200 millisecond network latency), threshold levels (e.g., above 100 millisecond network latency), and/or via any other suitable manner. Processing task parameters and/or variables comprise, for example and without limitation, one or more of processing task complexities, processing availability, processing latency, processing queue information based on previously allocated and/or active processes, network connection latency, network connection bandwidth, and/or any other suitable parameter and/or variable.

As noted above, in some embodiments, processing task parameters and/or variables may depend, at least in part, on an operational context associated with the task and/or associated AV 100. Operating contexts that may influence processing task allocation may comprise, for example and without limitation, vehicle speed, vehicle location, vehicle operating environment, weather conditions, proximity to other vehicles and/or objects, the density and/or relative speeds of other vehicles and/or objects, and/or like the like.

Table 1, presented below, illustrates a simplified non-limiting example of processing tasks and associated variables and/or parameters used in processing task allocation processes consistent with various aspects of the disclosed embodiments.

TABLE 1

| Processing | Safety | Acceptable Latency | Operating |
|---|---|---|---|
| Task | Level | (Processing/Network) | Context |
| Object | High | Very Low | High Vehicle Speed |
| Detection | | | |
| Object | High | Low | Slow Vehicle Speed |
| Detection | | | |
| Weather | Medium | Medium | Any Vehicle Speed |
| Estimation | | | |

It will be appreciated that a variety of processing task variables and/or parameters and/or operating contexts and/or conditions may be employed to allocate processing tasks between in vehicle processing systems 104 and/or remote resources 108, 110, and that any suitable variables and/or parameters and/or combinations of the same may be used in connection with the disclosed embodiments. Processing task variables, parameters, and/or operating context and/or conditions be expressed in a variety of formats and/or structures, which in some embodiments may be maintained in libraries and/or databases associated with systems and/or services engaged in processing task allocation processes (e.g., task allocation services 114a, 114b).

In at least one non-limiting example, processing tasks may be dynamically allocated between in-vehicle processing systems 104 and remote resources such as edge cloud 108 and/or cloud processing resources 110 based, at least in part, on identified real-time network conditions that may include network latency and/or bandwidth between the systems 104 and/or resources 108, 110. Consistent with various disclosed embodiments, processing tasks may be dynamically allocated based on, for example and without limitation, relative impact and/or importance to safe vehicle operation, network latency between an AV 100 and remote processing resources (e.g., edge cloud processing resources 108 and/or cloud processing resources 110), available network bandwidth between an AV 100 and remote processing resources 108, 110, and/or the like. In some embodiments, task allocation services and/or systems associated with the same may include built-in latency recognition (e.g., via latency detections services 116a, 116b), and therefore may add and/or remove tasks provisioned between local processing resources 104, edge cloud processing resources 108, and/or cloud processing resources 110 based on real-time network conditions.

In various embodiments, allocating processing tasks to edge cloud computing resources 108 (and/or other remote processing resources such as cloud processing resources 110) consistent with aspects of embodiments described herein may be used to provide a variety of additional and/or supplemental information to assist in local decision making by the AV 100. For example and without limitation, edge cloud processing 108 resources may implement CPU and/or GPU resource heavy algorithms that provide additional detection capabilities than that offered by more limited processing resources 104 local to the AV 100, thereby improving the safety and performance of the AV 100. In another non-limiting example, edge cloud computing resources 108 (and/or other remote processing resources such as cloud processing resources 110) may use higher resolution data and/or images than those used by processing resources 104 local to the AV 100 to detect objects that are further away from the AV 100. In yet a further non-limiting example, edge cloud computing resources 108 may perform real-time and/or near-real time map updates based on available data and then distribute these updates to a vehicle with relatively minimal delay.

Certain vehicle sensor data and infrastructure sensor data may be combined to produce higher quality and/or otherwise more detailed information relating to an environment around an AV 100. For example, raw LIDAR point data from a vehicle LIDAR system may be combined with raw LIDAR point data from an infrastructure sensor system 108. Consistent with various disclosed embodiments, such combined LIDAR point data may be processed by edge cloud processing resources 108 at relative high resolution to identify and/or classify associated objects when network latency between the AV 100 and the edge cloud processing resources 108 is below certain latency thresholds.

As discussed above, in various embodiments, processing tasks may be dynamically allocated based, at least in part, on detected processing latency and/or availability, network latency, connection bandwidth, other network traffic information, and/or the like between an AV 100 and remote processing resources 108, 110. In further embodiments, processing tasks may be further dynamically allocated based, at least in part, on various contextual information that may include, for example and without limitation, vehicle operational and/or other situational information.

In at least one non-limiting example, vehicle speed and/or location information may be used in connection with dynamically allocating processing tasks between vehicle, edge cloud, and/or cloud processing resources 104, 108, 110. For example, increased vehicle speed may require faster processing of sensor data 112 used to safely identify objects and determine vehicle control actions, and thus lower network latency may be required before allocating tasks to edge cloud processing resources 108 with increased vehicle speed. Similarly, an AV traversing highly trafficked areas such as intersections may also require faster processing of sensor data 112 used to safely determine vehicle control actions, and thus lower network latency may be required before allocating tasks to edge cloud processing 108 when an AV is proximate to and/or within such locations.

Allocated processing tasks (e.g., processing requests and/or the like) may be issued and/or otherwise communicated to associated processing resources (e.g., vehicle control and/or processing system 104 and/or remote processing resources 108, 110). In some embodiments, relevant and/or associated sensor data 112 may be communicated along with allocated processing tasks and/or associated requests. After performing the allocated processing tasks, a vehicle control and/or processing system 104, edge cloud processing resources 108, and/or cloud processing resources 110, may communicate resulting processed data 118 to appropriate systems for further processing and/or action.

For purposes of simplicity and explanation, data, which may comprise processed data, control actions, and/or the like, generated in response to an allocated processing task may be referred to and/or illustrated in connection with FIG. 1 generally as processed data 118. It will be appreciated, however, that depending on the context and/or implementation, consistent with various disclosed embodiments, processed data 118 and/or portions thereof as illustrated in FIG. 1 may originate from a vehicle control and/or processing system 104, edge cloud processing resources 108, and/or cloud processing resources 110, and/or from any combination of the same. Moreover, although described generally as processed data 118, it will be appreciated that in some embodiments, the processed data 118 may comprise one or more control actions to be implemented by the AV 100 and/or associated vehicle control and/or processing systems 104.

In various embodiments, one or more of the illustrated systems and/or services (e.g., the AV 100, infrastructure sensor system 106, edge cloud processing resources 108, cloud processing resources 110), may operate as a processed data intermediary and/or processed data aggregator. For example, the edge cloud processing resource 108 may communicate to the AV 100 processed data 118 that comprises processed data both received from the cloud processing resource 110 and generated by the edge cloud processing resource 108 in response to an allocated processing task. In a further example, the edge cloud computing resource 108 may receive processed data 118 from the cloud processing resource 110 and pass the processed data to the AV 100.

The AV 100 and/or associated vehicle processing and/or control systems 104 may engage in at least one control action based on received processed data 118. The control action may comprise a variety of actions relating to the control and/or operation of the AV 100 including, for example and without limitation, adjusting vehicle speed, adjusting vehicle acceleration, adjusting a path of the AV 100, and/or the like. It will be appreciated that a variety of control actions may be implemented based on processed data 118 consistent with various embodiments disclosed herein.

Embodiments of the disclosed systems and methods may be used in a variety of applications, contexts, and/or use cases. In at least one non-limiting example, advanced weather sensors such as visibility sensors, road surface friction sensors, etc. may be integrated in and/or otherwise located proximity to the road infrastructure. Weather data from several of such advanced weather sensors may be allocated for processing by edge cloud and/or cloud processing resources 108, 110 to provide an estimation as to driving conditions over a larger area with relatively high local accuracy.

In another non-limiting example, in some embodiments, an area map be continuously updated, with certain computationally intensive map processing performed in used edge cloud and/or cloud processing resources 108, 110. When relatively short latency edge computing is available, the map/or route can be enhanced in near real time. Vehicle sensors 102 may produce mapping data within a certain range of the AV 100, but if infrastructure sensors 106 are also available along a roadway, the mapping data range may be greatly increased. Maps may, in some implementations, be built and/or otherwise processed simultaneously when driving from a mapped area to new areas.

In a further non-limiting example, various aspects of the disclosed systems and methods may be used in connection with control and/or management of remote operation of a vehicle 100. Certain methods for remote vehicle operation may be dependent on the communication latency and/or situational awareness and/or the operational context of a vehicle 100. In detected low latency conditions, the vehicle 100 may be controlled directly by a remote operator in a way that the operator closes the actual steering and/or acceleration control loop. If latency increased, the remote operator can command shorter trajectories and the low-level control loops may be closed in locally in the vehicle 100.

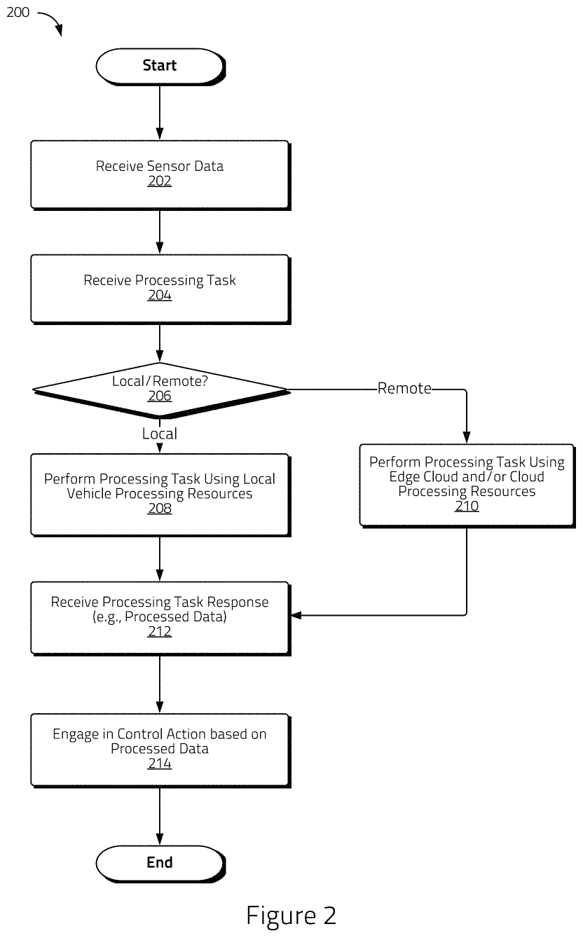

FIG. 2 illustrates a flow chart of a non-limiting example of a method 200 of dynamically allocating processing tasks associated with vehicle operation consistent with certain embodiments of the present disclosure. The illustrated method 200 may be implemented in a variety of ways, including using software, firmware, hardware, and/or any combination thereof. Various aspects of the illustrated method 200 and/or its constituent steps may be performed and/or otherwise implemented by systems associated with a vehicle, edge cloud processing resources, cloud processing resources, and/or any other service and/or system and/or combinations of services and/or systems that may be used to implement various aspects of the disclosed systems and methods.

At 202, sensor data may be received from one or more sensor systems. In some embodiments, the sensor systems may comprise one or more vehicle sensor systems that may include, for example and without limitation, one or more location sensor systems, speed sensor systems, accelerometers, LIDAR sensor systems, vision sensor systems, RADAR sensor systems, environmental sensor systems, and/or the like. In further embodiments, the sensor systems may comprise one or more infrastructure sensor systems that may include, for example and without limitation, one or more location sensor systems, speed sensor systems, accelerometers, LIDAR sensor systems, vision sensor systems, RADAR sensor systems, environmental sensor systems, and/or the like.

At least one data processing task associated with operation of the vehicle may be identified at 204 based on the received sensor data. In some embodiments, an indication of the at least one data processing task may be received. In further embodiments, the at least one data processing task may be identified contextually based on the received sensor data.

At 206, a determination may be made whether to allocate at least a portion of the at least one data processing task to at least one of a vehicle processing resource (e.g., a vehicle control and/or processing system) and a remote processing resource. For example, in various embodiments, a determination may be made whether to allocate at least a portion of the at least one data processing task to one or more vehicle control and/or processing systems, edge cloud processing systems (which may or may not be associated with an infrastructure sensor system), and/or cloud processing systems.

In some embodiments, the allocation process may be based on one or more task allocation parameters. In certain embodiments, the one or more task allocation parameters may comprise at least one network parameter associated with a communication channel with the remote processing resource (e.g., a communication channel between the vehicle and the at remote processing resource). The network parameter may comprise, for example and without limitation, one or more of a network connection signal strength, a network connection latency, and a network connection bandwidth, and/or the like.

In further embodiments, the one or more task allocation parameters may comprise at least one processing availability parameter associated with at least one of the vehicle processing resource and/or the remote processing resource. The processing availability parameter may comprise, for example and without limitation, an indication associated with a processing latency of the at least one of the vehicle processing resource and the remote processing resource, processing queues, processing availability information, and/or the like.

In certain embodiments, an operating context associated with the vehicle may be determined that may be used in connection with allocating the at least a portion of the at least one data processing task. Operating contexts used in connection with task allocation may comprise, for example and without limitation, one or more of a vehicle speed, weather conditions, location, proximity of other vehicles and/or objects, relative speed and/or movement of other vehicles and/or objects, and/or the like.

At 212, a response to the allocated processing task(s) may be received. For example, processed data may be received from the vehicle processing resource and/or the remote processing resource. In certain embodiments, different portions of a task may be allocated to different resources. For example, a first portion of a data processing task may be allocated to a vehicle processing resource, and a second portion of a data processing task may be allocated to a remote processing resource. Results and/or processed data may thus be received from each of the vehicle processing resource and/or the remote processing resource.

Based on the received results and/or processed data, the vehicle may engage in one or more control actions at 214. The control actions may comprise a variety of actions relating to the control and/or operation of the vehicle including, for example and without limitation, adjusting a vehicle speed, adjusting a vehicle acceleration, adjusting path of the vehicle, and/or the like. It will be appreciated that a variety of control actions may be implemented based on processed data and/or processing task results consistent with various embodiments disclosed herein.

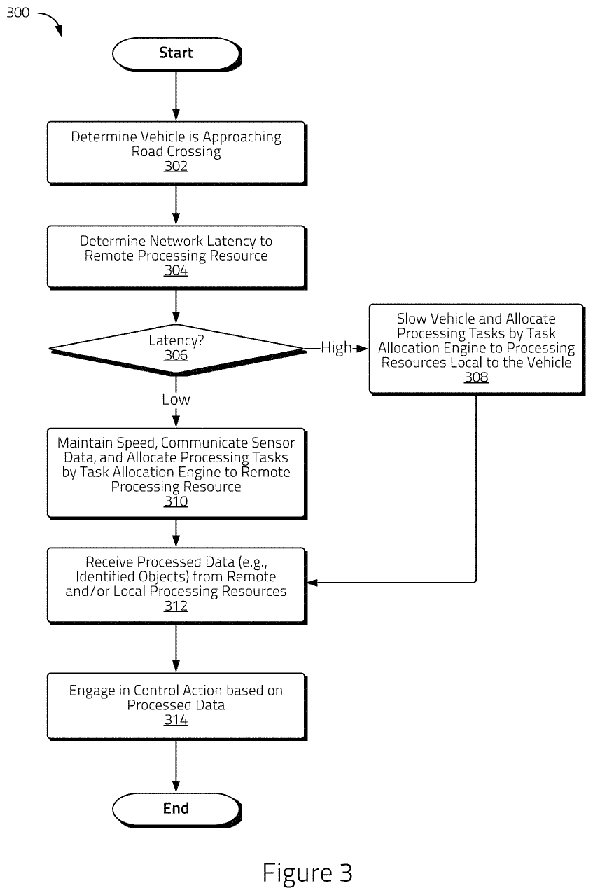

FIG. 3 illustrates a flow chart of a non-limiting example of a method 300 of dynamically allocating processing tasks based on communication channel latency consistent with certain embodiments of the present disclosure. Specifically, the illustrated method 300 may use vehicle operational conditions in conjunction with network latency detection to determine how to allocate processing tasks between processing resources local to the vehicle and edge cloud processing resources.

The illustrated method 300 may be implemented in a variety of ways, including using software, firmware, hardware, and/or any combination thereof. Various aspects of the illustrated method 300 and/or its constituent steps may be performed and/or otherwise implemented by systems associated with a vehicle, edge cloud processing resources, cloud processing resources, and/or any other service and/or system and/or combinations of services and/or systems that may be used to implement various aspects of the disclosed systems and methods.

As shown, an AV and/or an associated system may determine at 302 that it is approaching a location that may involve an assessment of whether the vehicle should engage in one or more control actions. For example, for safety purposes, when traversing an intersection, road crossing, and/or other trafficked area and/or location, an AV may likely need to assess whether it should engage in one or more control actions proximate to and/or within the location. In some embodiments, determining that the vehicle is approaching a specific location may be based, at least in part, on location information generated by AV sensor systems (e.g., GPS systems) and/or and mapping information.

At 304, one or more network parameters may be identified to determine network conditions between an AV and one or more remote systems such as, for example and without limitation, edge cloud and/or cloud processing resources. For example, network latency, connection bandwidth, and/or other network traffic information may be identified associated with a network connection between and AV and edge cloud processing resources.

The identified network parameters may be compared at 306 with one or more network connection parameter thresholds articulated in one or more variables and/or parameters associated with a processing task. For example, an identified network connection latency may be compared with one or more network latency thresholds to determine whether the identified latency is above a threshold associated with higher network latency or at and/or below a threshold associated with lower network latency.

In some embodiments, the one or more thresholds may be dynamic based on contextual information relating to the operation of the AV and/or an associated operational environment. For example, increased vehicle speed may require faster processing of sensor information to safely determine vehicle control actions, and thus lower network latency thresholds may be implemented to determine whether to allocate tasks to edge cloud processing when the vehicle is above certain threshold speeds. Similarly, highly trafficked and/or more operationally complex areas such as an intersection may require faster processing of sensor information to safely determine vehicle control actions, and thus lower network latency thresholds may be implemented to determine whether to allocate tasks to edge cloud processing when the vehicle is approaching a threshold distance from and/or located within such operational areas. Additional cameras and/or other sensors could further be used with support of remote processing resources such as edge cloud processing resources in difficult lighting and/or traffic conditions.

In contrast, at lower vehicle speeds, fast processing of sensor data may be less important from a safety perspective due to increased control action time, and thus higher network latency thresholds may be implemented to determine whether to allocate tasks to edge cloud processing when the vehicle is above certain threshold speeds. Similarly, less trafficked and/or less operationally complex areas such as a rural road may allow for slower processing of sensor information to safely determine vehicle control actions without compromising safety due to increased reaction time, and thus higher network latency thresholds may be implemented to determine whether to allocate tasks to edge cloud processing when the is operating in such a context.

In the illustrated example, if identified network latency exceeds an operative network latency threshold, certain processing tasks may be allocated to processing resources local to the vehicle and the method 300 may proceed to 308. In some embodiments, to increase reaction time (and by extension available processing response time), one or more vehicle operation control actions may be implemented. For example, as shown in the illustrated method 300, the vehicle may be slowed to provide increased processing response time for tasks allocated to local processing resources.

If identified network latency is below an operative network latency threshold, the processing tasks may be allocated to remote processing resources such as, for example, edge cloud processing resources, with the method 300 proceeding to 310. In various embodiments, due to reduced network latency and increased processing power afforded by the edge cloud processing resources, the vehicle speed may remain unchanged. It will be appreciated, however, that based on identified network conditions, a variety of different control actions may be implemented in conjunction with processing task allocation that may balance vehicle operational safety and processing performance.

In some embodiments, one or more suitable statistical analysis methods may be employed that use historical network connectivity and/or condition information to estimate and/or otherwise predict network conditions for a period after a proposed task has been allocated to edge cloud and/or cloud processing resources. Such predicted network conditions may be used in connection with determining whether to allocate tasks to remote processing resources methods consistent with embodiments disclosed herein. The period may comprise a set and/or otherwise fixed period and/or may be vary based, at least in part, on an estimated and/or otherwise expected time for a remote processing resource to perform the task and return an associated result. In certain embodiments, historic network connectivity and/or condition information used in connection with estimating predicated network conditions may be associated with a particular location, time of day, amount of network traffic, and/or any other suitable parameter.

As illustrated in connection with FIG. 3, processed data (e.g., object identification information identified from processed sensor data) may be returned from the local vehicle processing resources and/or the remote processing resources (e.g., edge cloud processing resources) at 312. Based on the processed data, at 314, the vehicle may engage in one or more control actions including, for example and without limitation, adjusting vehicle speed, adjusting the vehicle path to avoid objects, and/or the like.

It will be appreciated that a number of variations can be made to the architecture, relationships, and examples presented in connection with FIGS. 1-3 within the scope of the inventive body of work. For example, certain illustrated and/or described processing steps may be performed by a single system and/or service and/or be distributed between multiple systems and/or services. Moreover, certain information processing workflows may be modified to include additional processing steps, eliminate certain processing steps, and/or reorder certain processing steps. Thus, it will be appreciated that the architecture, relationships, and examples presented in connection with FIGS. 1-3 are provided for purposes of illustration and explanation, and not limitation.

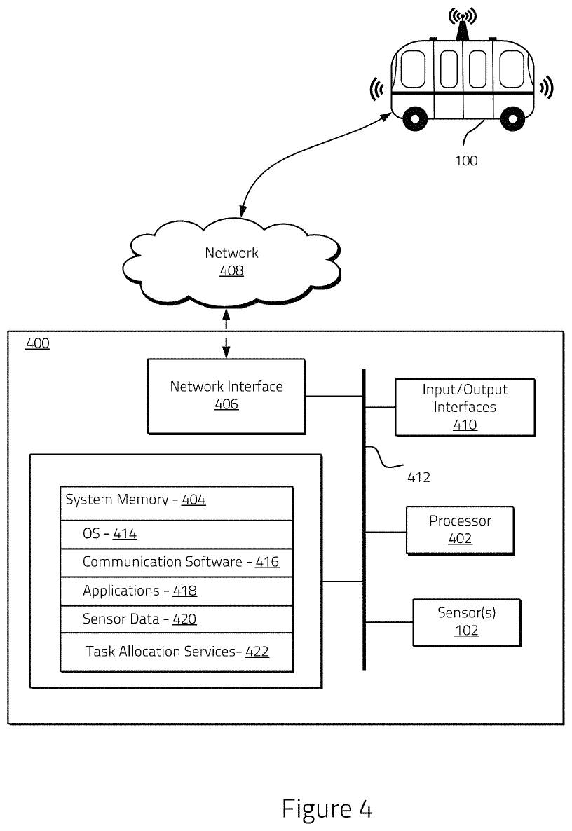

FIG. 4 illustrates a non-limiting example of a system 400 that may be used to implement certain embodiments of the systems and methods of the present disclosure. Although illustrated as a vehicle processing system, it will be appreciated that certain elements associated with the illustrated system may be included in remote processing resources and/or infrastructure sensors associated with a vehicle 100 (e.g., edge cloud and cloud processing resources) configured to implement aspects of the embodiments of the systems and methods disclosed herein.

As illustrated in FIG. 4, the system 400 may include: a processing unit 402; system memory 404, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 402; a port for interfacing with one removable memory that may include one or more diskettes, optical storage mediums, and/or other non-transitory computer-readable storage mediums (e.g., flash memory, thumb drives, USB dongles, solid state storage, compact discs, DVDs, etc.); a network interface 406 for communicating with other systems and/or processing resources (including systems associated with an AV) via one or more network connections 408 using one or more communication technologies and/or channels; a user interface 410 that may include a display and/or one or more input/output devices such as, for example, a touchscreen, a keyboard, a mouse, a track pad, and the like; one or more vehicle sensors 102 that may comprise any of the types of sensors described herein; and one or more busses 412 for communicatively coupling the elements of the system 400.

The operation of the system 400 may be generally controlled by the processing unit 402 by executing software instructions and programs stored in the system memory 404 and/or internal memory of the processing unit 402. The system memory 404 may store a variety of executable programs or modules for controlling the operation of the system. For example, the system memory 404 may include an operating system (“OS”) 414 that may manage and coordinate, at least in part, system hardware resources and provide for common services for execution of various applications, modules, and/or services.

The system memory 404 may further include, without limitation, communication software 416 configured to enable in part communication with and by the system 400; one or more applications 418; sensor data 412; processing task allocation services 422 and/or modules consistent with various aspects of the disclosed embodiments; and/or any other information and/or applications configured to implement embodiments of the systems and methods disclosed herein.

The systems and methods disclosed herein are not limited to any specific computer, device, service, or other apparatus architecture and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Moreover, it will be appreciated that any examples described herein, including examples that may not be specifically identified as non-limiting, should not be viewed as limiting and/or otherwise restrictive. Accordingly, the present embodiments are to be considered as illustrative and not restrictive, and the invention is not to be limited to the details given herein but may be modified with the scope and equivalents of the appended claims.

What is claimed is:

1. A method for allocating vehicle processing tasks between a vehicle processing system and at least one remote processing system performed by the vehicle processing system, the vehicle processing system comprising a processor and a computer-readable storage medium storing instructions that, when executed by the processor, cause the vehicle processing system to perform the method, the method comprising:
receiving sensor data from one or more sensor systems;
identifying at least one data processing task associated with operation of the vehicle based on the received sensor data;
allocating at least a portion of the at least one data processing task to at least one of a vehicle processing resource and a remote processing resource based on or more task allocation parameters associated with the vehicle;
receiving processed data from the at least one of the vehicle processing resource and the remote processing resource; and
engaging in at least one vehicle control action based on the received processed data.

2. The method of claim 1, wherein the one or more sensor systems comprise one or more vehicle sensor systems.

3. The method of claim 2, wherein the one or more vehicle sensor systems comprise one or more of a location sensor system, a speed sensor system, an accelerometer, a LIDAR sensor system, a vision sensor system, a RADAR sensor system, and an environmental sensor system.

4. The method of claim 1, wherein the one or more sensor systems comprise one or more infrastructure sensor systems.

5. The method of claim 4, wherein the one or more infrastructure sensor systems comprises one or more one or more a location sensor system, a speed sensor system, a LIDAR sensor system, a vision sensor system, a RADAR sensor system, and an environmental sensor system.

6. The method of claim 1, wherein identifying the at least one data processing task comprises receiving, by the vehicle processing system, an indication of the at least one data processing task.

7. The method of claim 1, wherein the vehicle processing resource is associated with the vehicle processing system.

8. The method of claim 1, wherein the remote processing resource comprises an edge cloud processing system.

9. The method of claim 1, wherein the edge cloud processing system is associated with an infrastructure sensor system.

10. The method of claim 1, wherein the remote processing resource comprises a cloud processing system.

11. The method of claim 1, wherein the one or more task allocation parameters comprise at least one network parameter associated with a communication channel with the remote processing resource.

12. The method of claim 11, wherein the at least one network parameter comprises at least one of a network connection signal strength, a network connection latency, and a network connection bandwidth.

13. The method of claim 1, wherein the one or more task allocation parameters comprise at least one processing availability parameter associated with at least one of the vehicle processing resource and the remote processing resource.

14. The method of claim 13, wherein the at least one processing availability parameter comprises an indication associated with a processing latency of the at least one of the vehicle processing resource and the remote processing resource.

15. The method of claim 1, wherein the method further comprises determining an operating context associated with the vehicle.

16. The method of claim 15, wherein the operating context comprises one or more a vehicle speed, weather conditions, vehicle location, vehicle proximity to other vehicles, and vehicle proximity to objects.

17. The method of claim 16, wherein allocating the at least a portion of the at least one data processing task is based, at least in part, on the determined operating context associated with the vehicle.

18. The method of claim 1, wherein allocating the at least a portion of the at least one data processing task comprises:
allocating a first portion of the at least one data processing task to the vehicle processing resource; and
allocating a second portion of the at least one data processing task to the remote processing resource.

19. The method of claim 18, wherein receiving the processed data comprises:
receiving first processed data from the vehicle processing resource; and
receiving second processed data from the remote processing resource.

20. The method of claim 1, wherein the vehicle comprises one or more of a fully autonomous vehicle, a semi-autonomous vehicle, and a vehicle with a driver-assistance. system.
